(19) United States
(12) Patent Application Publication
(10) Pub. No.: US 2023/0370871 A1
(43) Pub. Date: Nov. 16, 2023

(54) METHOD FOR REMOTE DEBUGGING OF GATEWAY WHEN WAN CONNECTION OF GATEWAY IS LOST

(71) Applicant: ARRIS Enterprises LLC, Suwanee, GA (US)

(72) Inventor: Bo CHEN, Shenzhen, Guangdong (CN)

(21) Appl. No.: 18/026,177

(22) PCT Filed: Sep. 16, 2020
(86) PCT No.: PCT/CN2020/115611

§ 371 Date: Mar. 14, 2023

(51) Int. Cl. H04W 24/04; H04L 41/0654; G06F 11/26

(52) U.S. Cl. CPC H04W 24/04; H04L 41/0654; G06F 11/26; H04W 84/12

(57) ABSTRACT

A method for remotely debugging a gateway device includes causing the gateway device to enter a diagnose mode to collect debug information when a wide area network (WAN) connection of the gateway device is lost. The gateway device transmits the debug information to an electronic device associated with a local area network (LAN) of the gateway device, receives command line interface (CLI) instructions from the electronic device based on the debug information, and performs one or more debug operations based on the CLI instructions. When a home SSID associated with the gateway device is functioning and a wireless LAN connection associated with the home SSID is active, the gateway device communicates with the electronic device over the wireless LAN connection. When the home SSID is not functioning and the WLAN connection is inactive, the gateway device communicates with the electronic device over a wired Ethernet connection.

### BACKGROUND

A residential gateway device (e.g., a cable modem and/or router at a customer's home) may experience certain issues that require debugging to be performed on the gateway device. In some cases, a technician of a Multiple-System Operator (MSO) may be able to communicate remotely with the gateway device in order to collect logs and/or upgrade the firmware of the gateway device to address these issues. Various remote debugging techniques are known in the related art. For example, the MSO technician may use simple network management protocol (SNMP)/Technical Report 069 (TR-069), or may set up an encrypted tunnel to the gateway device using secure shell (SSH), or may use a graphical user interface (GUI) in order to perform debugging operations on the gateway device from a remote device.

However, all of these known remote debugging techniques rely on a wide area network (WAN) connection of the gateway device to work. Thus, if a situation exists that causes the gateway device to lose its WAN connection, a problem arises that the MSO technician will not be able to communicate with the gateway device remotely in order to perform debugging operations using any of these known techniques. For example, the gateway device may have a coaxial radio frequency (RF) connectivity problem, which prevents the gateway device from ranging and registering to a cable modem termination system (CMTS). Other problems that may occur at a gateway device may involve unplugged or damaged cables, a faulty connection, or interference. In a situation where the WAN connection is down, the MSO must send a technician out into the field (e.g., to the customer's home) to communicate directly with the gateway device (e.g., using LAN side GUI of the gateway) in order to perform the debugging operations locally on site.

Therefore, it would be desirable to provide a solution that enables debugging operations to be performed (and/or configuration files to be updated, and/or firmware to be upgraded) remotely, even when the WAN connection of the gateway device is lost.

### SUMMARY

To address the problem with the known remote debugging techniques discussed above, a diagnose mode is introduced on a gateway device according to aspects of the present disclosure. In some example embodiments, causing the gateway device to enter the diagnose mode can be triggered using a wireless connection between a mobile device of a user (e.g., the customer's smartphone or other similar electronic device), via a home network controller (HNC) mobile app installed on the mobile device of the user. Additionally or alternatively, the user can trigger the gateway device to enter the diagnose mode using the LAN side GUI of the gateway device or by pressing a physical button on the gateway device. Additionally or alternatively, causing the gateway device to enter the diagnose mode can be triggered using a wired connection (e.g., Ethernet) between a customer premises equipment (CPE) and the gateway device.

An aspect of the present disclosure provides a gateway device including a memory storing instructions for enabling the gateway device to be debugged remotely when a wide area network (WAN) connection of the gateway device is lost, and a processor configured to execute the instructions to enter a diagnose mode to collect debug information when the WAN connection of the gateway device is lost. The processor is also configured to transmit the debug information to an electronic device associated with a local area network (LAN) of the gateway device, receive command line interface (CLI) instructions from the electronic device based on the debug information, and perform one or more debug operations on the gateway device based on the CLI instructions.

In an aspect of the present disclosure, the electronic device associated with the LAN of the gateway device is a mobile device. When a home service set identifier (SSID) associated with the gateway device is functioning and a wireless local area network (WLAN) connection associated with the home SSID is active, the processor of the gateway device is configured to execute the instructions to transmit the debug information to the mobile device over the WLAN connection associated with the home SSID of the gateway device, and receive the CLI instructions from the mobile device over the WLAN connection associated with the home SSID of the gateway device.

In an aspect of the present disclosure, entering the diagnose mode is triggered via one of a home network controller (HNC) mobile application executing on the mobile device, a LAN side graphical user interface (GUI) of the gateway device, or a physical button on the gateway device.

In an aspect of the present disclosure, the electronic device associated with the LAN of the gateway device is a customer premises equipment (CPE). When a home service set identifier (SSID) associated with the gateway device is not functioning and a wireless local area network connection (WLAN) associated with the home SSID is inactive, the processor of the gateway device is configured to execute the instructions to transmit the debug information to the CPE over a wired Ethernet connection, and receive the CLI instructions from the CPE over the wired Ethernet connection.

In an aspect of the present disclosure, upon entering the diagnose mode, the processor of the gateway device is configured to execute the instructions to collect the debug information, wherein the collected debug information includes one or more of a user ID, a timestamp, a media access control (MAC) address of the gateway device, a radio frequency (RF) transmission power, last used frequency and DOCSIS channel, last reset reasons, and memory remaining. The processor is also configured to execute the instructions to store the collected debug information in a local file, and encrypt the local file storing the debug information.

An aspect of the present disclosure provides a non-transitory computer-readable medium storing instructions for enabling a gateway device to be debugged remotely when a wide area network (WAN) connection of the gateway device is lost. The instructions when executed by a processor of the gateway device cause the gateway device to perform operations, including the operations described above.

An aspect of the present disclosure provides a method for remotely debugging a gateway device when a wide area network (WAN) connection of the gateway device is lost. The method includes causing the gateway device to enter a diagnose mode to collect debug information when the WAN connection of the gateway device is lost, transmitting the debug information from the gateway device to an electronic device associated with a local area network (LAN) of the gateway device, receiving command line interface (CLI) instructions at the gateway device from the electronic device based on the debug information, and performing one or more debug operations on the gateway device based on the CLI instructions.

In an aspect of the present disclosure, the method includes the operations performed by the gateway device as described above.

In an aspect of the present disclosure, the method further includes receiving the debug information at the mobile device from the gateway device via the WLAN connection associated with the home SSID, disconnecting the mobile device from the home SSID, and connecting the mobile device with an available public hotspot SSID or a cellular network for internet access, automatically via the HNC mobile application, and upon the mobile device gaining internet access, transmitting the debug information from the mobile device to a destination address of an multiple services operator (MSO) technician via the HNC mobile application using a WLAN connection associated with the available public hotspot SSID or using the cellular network. The destination address of the MSO technician is configured on the HNC mobile application and is associated with an email account of the MSO technician or a trivial file transfer protocol (TFTP) server accessible by the MSO technician.

In an aspect of the present disclosure, the method further includes receiving the CLI instructions to perform one or more of debugging operations on the gateway device, updating a configuration file stored on the gateway device, or upgrading firmware of the gateway device, at the mobile device from the MSO technician via the HNC mobile application using the WLAN connection associated with the public hotspot SSID or the cellular network, disconnecting the mobile device from the available public hotspot SSID or the cellular network, and reconnecting the mobile device with the home SSID, automatically via the HNC mobile application, and transmitting the CLI instructions from the mobile device to the gateway device via the HNC mobile application using the WLAN connection associated with the home SSID for execution by the gateway device.

In an aspect of the present disclosure, the method further includes receiving the debug information at the CPE from the gateway device over the wired Ethernet connection, disconnecting the CPE from the wired Ethernet connection and connecting the CPE to a different network for internet access, and upon the CPE gaining internet access, transmitting the debug information from the CPE to a destination address of an MSO technician over a wired or wireless connection of the CPE to the different network. The destination address of the MSO technician is configured on the CPE and is associated with an email account of the MSO technician or a trivial file transfer protocol (TFTP) server accessible by the MSO technician. The method further includes receiving the CLI instructions to perform one or more of debugging operations on the gateway device, updating a configuration file stored on the gateway device, or upgrading firmware of the gateway device, at the CPE from a remote device of the MSO technician over the wired or wireless connection of the CPE to the different network, disconnecting the CPE from the different network and reconnecting the CPE to the gateway device using the wired Ethernet connection, and transmitting the CLI instructions from the CPE to the gateway device using the wired Ethernet connection for execution by the gateway device.

An aspect of the present disclosure provides an electronic device associated with a local area network (LAN) of a gateway device, the electronic device including a memory storing instructions for remotely debugging the gateway device when a wide area network (WAN) connection of the gateway device is lost, and a processor configured to execute the instructions to cause the gateway device to enter a diagnose mode to collect debug information when the WAN connection of the gateway device is lost, receive the debug information from the gateway device, transmit the debug information to a remote device of a multiple systems operator (MSO) technician, receive command line interface (CLI) instructions from the remote device of the MSO technician based on the debug information, and transmit the CLI instructions to the gateway device for execution.

In an aspect of the present disclosure, the electronic device is a mobile device, and the instructions stored in the memory are part of a home network controller (HNC) mobile application. When a home service set identifier (SSID) associated with the gateway device is functioning and a wireless local area network (WLAN) connection associated with the home SSID is active, the processor of the mobile device is further configured to execute the instructions of the HNC mobile application to receive the debug information from the gateway device via the WLAN connection associated with the home SSID, disconnect the mobile device from the home SSID, and connect the mobile device with an available public hotspot SSID or a cellular network for internet access, and upon the mobile device gaining internet access, transmit the debug information to a destination address of the MSO technician via the HNC mobile application using a WLAN connection associated with the available public hotspot SSID or using the cellular network. The destination address of the MSO technician is configured on the HNC mobile application and is associated with an email account of the MSO technician or a trivial file transfer protocol (TFTP) server accessible by the MSO technician. The processor of the mobile device is further configured to execute the instructions on the HNC mobile application to receive the CLI instructions to perform one or more of debugging operations on the gateway device, update a configuration file stored on the gateway device, or upgrade firmware of the gateway device, from the remote device of the MSO technician over the WLAN connection associated with the available public hotspot SSID or the cellular network, disconnect from the available public hotspot SSID or the cellular network, and automatically re-connect with the home SSID, and transmit the CLI instructions to the gateway device over the WLAN connection associated with the home SSID for execution by the gateway device.

In an aspect of the present disclosure, the electronic device is a customer premises equipment (CPE). When a home service set identifier (SSID) associated with the gateway device is not functioning and a wireless local area network (WLAN) connection associated with the home SSID is inactive, the processor of the CPE is configured to execute the instructions to receive the debug information from the gateway device over a wired Ethernet connection, disconnect the CPE from the wired Ethernet connection and connect the CPE to a different network for internet access, and upon the CPE gaining internet access, transmit the debug information to a destination address of the MSO technician using a wired or wireless connection of the CPE to the different network. The destination address of the MSO technician is configured on the CPE and is associated with an email account of the MSO technician or a trivial file transfer protocol (TFTP) server accessible by the MSO technician. The processor of the CPE is further configured to receive the CLI instructions to perform one or more of debugging operations on the gateway device, update a configuration file stored on the gateway device, or upgrade firmware of the gateway device, from the remote device of the MSO technician over the wired or wireless connection of the CPE to the different network, disconnect the CPE from the different network and reconnect the CPE to the gateway device using the wired Ethernet connection, and transmit the CLI instructions to the gateway device over the wired Ethernet connection for execution by the gateway device.

With the solutions according to various aspects of the present disclosure, the MSO technician no longer needs to be present on site at the customer's home to perform debugging operations locally at the gateway device, and the MSO technician can still provide various forms of support remotely even when the gateway device loses its WAN connection.

### BRIEF DESCRIPTION OF DRAWINGS

In the drawings, like reference numbers generally indicate identical, functionally similar, and/or structurally similar elements.

FIG. 1 is a schematic diagram of a system, according to an embodiment of the present disclosure;

FIG. 2 is a more detailed block diagram illustrating various components of an exemplary gateway device, client device, and wireless extender implemented in the system of FIG. 1 according to an embodiment of the present disclosure;

FIG. 3 is a more detailed block diagram illustrating certain components of an exemplary gateway device and an exemplary wide area network adaptor implemented in the system of FIG. 1 according to an embodiment of the present disclosure;

FIG. 4 is a flow chart of a method for remotely debugging a gateway device according to an example embodiment of the present disclosure; and

FIG. 5 is a flow chart illustrating a method for remotely debugging a gateway device according to an example embodiment of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples and not for the purpose of limiting the present disclosure as defined by the appended claims and their equivalents. The words and phrases used in the following description and claims are merely used to enable a clear and consistent understanding of the present disclosure. In addition, descriptions of well-known structures, functions, and configurations may be omitted for clarity and conciseness. Those of ordinary skill in the art will recognize that various changes and modifications of the examples described herein can be made without departing from the spirit and scope of the present disclosure.

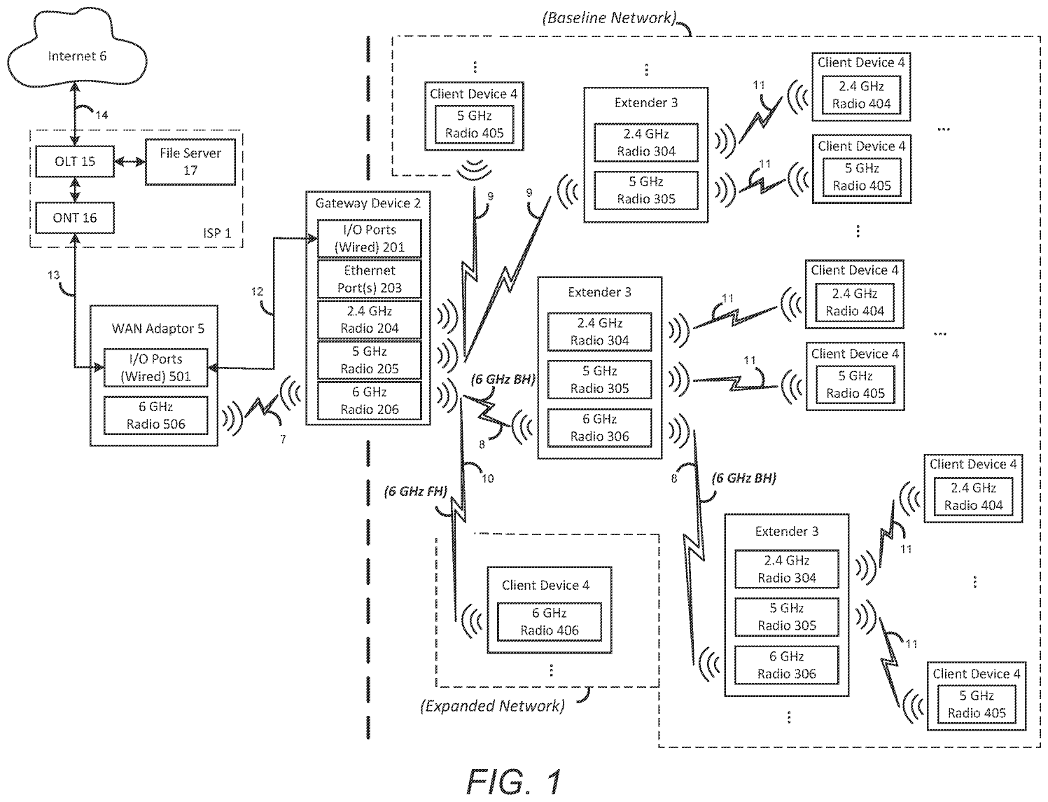

FIG. 1 is a schematic diagram of a system, according to an embodiment of the present disclosure.

It should be appreciated that various example embodiments of inventive concepts disclosed herein are not limited to specific numbers or combinations of devices, and there may be one or multiple of some of the aforementioned electronic apparatuses in the system, which may itself consist of multiple communication networks and various known or future developed wireless connectivity technologies, protocols, devices, and the like.

As shown in FIG. 1, the main elements of the system include a gateway device 2 connected to the Internet 6 via an Internet Service Provider (ISP) 1 and a wide area network (WAN) adaptor 5, and also connected to different wireless devices such as wireless extenders 3 and client devices 4. The system shown in FIG. 1 includes wireless devices (e.g., wireless extenders 3 and client devices 4) that may be connected in one or more wireless networks (e.g., private, guest, iControl, backhaul network, or Internet of things (IoT) network) within the system. Additionally, there could be some overlap between wireless devices (e.g., wireless extenders 3 and client devices 4) in the different networks. That is, one or more network devices could be located in more than one network. For example, the wireless extenders 3 could be located both in a private network for providing content and information to a client device 4 and also included in a backhaul network or an iControl network.

Starting from the top of FIG. 1, the ISP 1 can be, for example, a streaming video provider or any computer for connecting the gateway device 2 to the Internet 6. The ISP 1 may have various hardware components associated therewith, including but not limited to an optical line terminal (OLT) 15, an optical network terminal (ONT) 16, and a file server 17.

The connection 14 between the Internet 6 and the ISP 1 can be implemented using a wide area network (WAN), a virtual private network (VPN), metropolitan area networks (MANs), system area networks (SANs), a DOCSIS network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a 2G, 3G, 4G or 5G network, for example.

The wide area network (WAN) adaptor 5 can be a hardware electronic device that provides an interface between the Internet 6 via the ISP 1, and the gateway device 2. The WAN adaptor 5 may include various components, including but not limited to input/output (I/O) ports 501 (wired connection interfaces) such as Ethernet ports, coaxial RF cable ports, fiber optic ports, or the like, and a 6 GHz radio 506 (wireless connection interface). The WAN adaptor 5 “adapts” the 6 GHz interface to an interface supported by the ISP-provided WAN access device (e.g., a connection 13, such as Ethernet, to the ONT 16). Thus, the WAN adaptor 5 can serve as a “6 GHz to Ethernet Bridge” connecting the gateway device 2 to the Internet 6, according to some example embodiments of the present disclosure. Additionally or alternatively, the connection interface between the WAN adaptor 5 and the gateway device 2 may be implemented via a wired connection (e.g., Ethernet, coaxial RF cable, etc.) using one of the I/O ports 501. Other types of WAN access devices include a DOCSIS modem, a DSL modem, and a fixed wireless modem. In some example embodiments, the WAN adaptor 5 may be a separate device that sits in between an ISP-provided modem, modem/router combination or the like, and the gateway device 2.

The connection 13 between the ISP 1 (e.g., via the ONT 16) and the WAN adaptor 5 can be implemented using a wide area network (WAN), a virtual private network (VPN), metropolitan area networks (MANs), system area networks (SANs), a DOCSIS network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a 2G, 3G, 4G or 5G network, for example. The connection 13 can further include as some portion thereof a broadband mobile phone network connection, an optical network connection, or other similar connections. For example, the connection 13 can also be implemented using a fixed wireless connection that operates in accordance with, but is not limited to, 3rd Generation Partnership Project (3GPP) Long Term Evolution (LTE) or 5G protocols. It is also contemplated by the present disclosure that connection 13 between the WAN adaptor 5 and the ISP 1 is capable of providing connections between the gateway device 2 and a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G or 5G network, for example.

The gateway device 2 can be, for example, a hardware electronic device that may be a combination modem and network gateway device that combines the functions of a modem, an access point (AP), and/or a router for providing content received from the ISP 1 to network devices (e.g., wireless extenders 3 and client devices 4) in the system. It is also contemplated by the present disclosure that the gateway device 2 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The gateway device 2 may also be referred to as a residential gateway (RG), a broadband access gateway, a home network gateway, a home router, or a wireless access point (AP).

The gateway device 2 can include one or more wired interfaces, including but not limited to input/output port(s) 201 (e.g., an Ethernet port, a coaxial RF cable port, a fiber optic cable port, or the like) and Ethernet port(s) 203. The gateway device 2 can also include multiple wireless interfaces, including but not limited to a 2.4 GHz radio 204, a 5 GHz radio 205, and a 6 GHz radio 206.

The connection 7 between the gateway device 2 and the WAN adaptor 5 and the connection 8 between the gateway device 2 and the wireless extenders 3 are implemented through a wireless connection that operates in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. One or more of the connection 7 and/or the connection 8 can also be a wired Ethernet connection.

The connection 7 between the gateway device 2 and the WAN adaptor 5 may be implemented via the 6 GHz radio 206 of the gateway device 2 and the 6 GHz radio 506 of the WAN adaptor 5, for example. The connection 7 enables the gateway device 2 and the WAN adaptor 5 to establish a dedicated 6 GHz wireless backhaul (6 GHz BH) according to some example embodiments of the present disclosure.

Additionally or alternatively, the connection 12 between the gateway device 2 and the WAN adaptor 5 may be implemented using their respective wired interfaces (e.g., Ethernet, cable, fiber optic, or the like), such as via the I/O port(s) 201 of the gateway device 2 and an I/O port 501 of the WAN adaptor 5, for example. The connection 12 enables the gateway device 2 and the WAN adaptor 5 to establish a wired backhaul according to some other example embodiments of the present disclosure.

The connection 8 between the gateway device 2 and the wireless extenders 3 can be implemented using the 6 GHz radio 206 of the gateway device 2 and the 6 GHz radios 306 of the wireless extenders 3, for example. The connection 8 enables the gateway device 2 and the wireless extenders 3 to establish a dedicated 6 GHz wireless backhaul (6 GHz BH) according to example embodiments of the present disclosure. However, the connection 8 could also be implemented using respective wired interfaces (e.g., Ethernet, cable, fiber optic, or the like) in some alternative example embodiments.

The connection 9 between the gateway device 2, the wireless extenders 3, and client devices 4 can be implemented using a wireless connection in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz bands, or 60 GHz bands. Additionally, the connection 9 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connection 9 can include connections to a media over coax (MoCA) network. One or more of the connections 9 can also be a wired Ethernet connection.

The wireless extenders 3 can be, for example, hardware electronic devices such as access points (APs) used to extend the wireless network by receiving the signals transmitted by the gateway device 2 and rebroadcasting the signals to, for example, client devices 4, which may out of range of the gateway device 2. The wireless extenders 3 can also receive signals from the client devices 4 and rebroadcast the signals to the gateway device 2, or other client devices 4.

The connection 8 between respective wireless extenders 3 is implemented through a wireless connection that operates in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. The connection 8 can also be a wired Ethernet connection.

The connection 8 between respective wireless extenders 3 can be implemented using the 6 GHz radio 306 of the wireless extenders 3, for example. The connection 8 enables the wireless extenders 3 to establish a dedicated 6 GHz wireless backhaul (6 GHz BH) according to example embodiments of the present disclosure. However, the connection 8 could also be implemented using respective wired interfaces (e.g., Ethernet, cable, fiber optic, or the like) in some alternative example embodiments.

The client devices 4 can be, for example, hand-held computing devices, personal computers, electronic tablets, smart phones, smart speakers, Internet-of-Things (IoT) devices, iControl devices, portable music players with smart capabilities capable of connecting to the Internet, cellular networks, and interconnecting with other devices via Wi-Fi and Bluetooth, or other wireless hand-held consumer electronic devices capable of executing and displaying content received through the gateway device 2. Additionally, the client devices 4 can be a television (TV), an IP/QAM set-top box (STB) or a streaming media decoder (SMD) that is capable of decoding audio/video content, and playing over OTT or MSO provided content received through the gateway device 2.

The connection 10 between the gateway device 2 and the client device 4 is implemented through a wireless connection that operates in accordance with, but is not limited to, any IEEE 802.11 protocols. Additionally, the connection 10 between the gateway device 2 and the client device 4 can also be implemented through a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G or 5G network, for example. The connection 10 can also be implemented using a wireless connection in accordance with Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. One or more of the connections 10 can also be a wired Ethernet connection.

The connection 10 between the client device 4 and the gateway device 2 can be implemented using the 6 GHz radio 406 of the client device 4 and the 6 GHz radio 206 of the gateway device 2, for example. The connection 10 enables the gateway device 2 and the client device 4 to establish a 6 GHz wireless fronthaul (6 GHz FH) according to example embodiments of the present disclosure. However, the connection 10 could also be implemented using respective wired interfaces (e.g., Ethernet, cable, fiber optic, or the like) in some alternative example embodiments.

The connection 11 between the wireless extenders 3 and the client devices 4 is implemented through a wireless connection that operates in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. Additionally, the connection 11 can be implemented using a wireless connection that operates in accordance with, but is not limited to, RF4CE protocol, ZigBee protocol, Z-Wave protocol, or IEEE 802.15.4 protocol. Also, one or more of the connections 11 can be a wired Ethernet connection.

The connection 11 between the wireless extenders 3 and the client devices 4 can be implemented using the 2.4 GHz radio 404 or the 5 GHz radio 405 of the client devices 4 and the 2.4 GHz radio 304 or the 5 GHz radio 305 of the wireless extenders 3, for example. The connection 11 enables the wireless extenders 3 and the client devices 4 to establish a 2.4 GHz wireless fronthaul or a 5 GHz wireless fronthaul, according to example embodiments of the present disclosure. However, the connection 11 could also be implemented using respective wired interfaces (e.g., Ethernet, cable, fiber optic, or the like) in some alternative example embodiments.

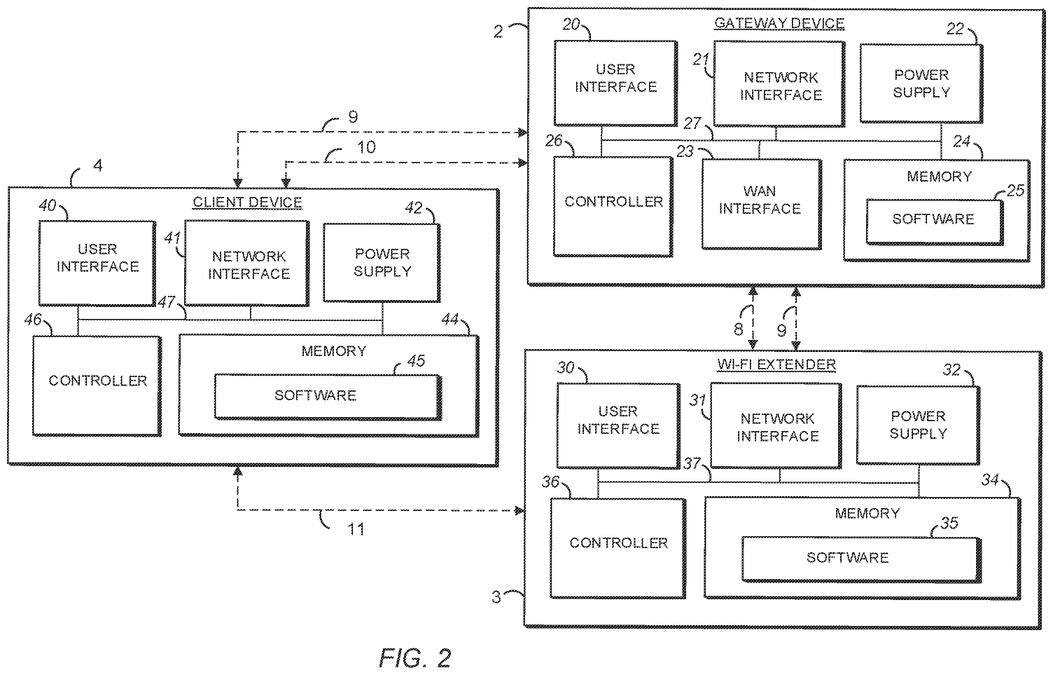

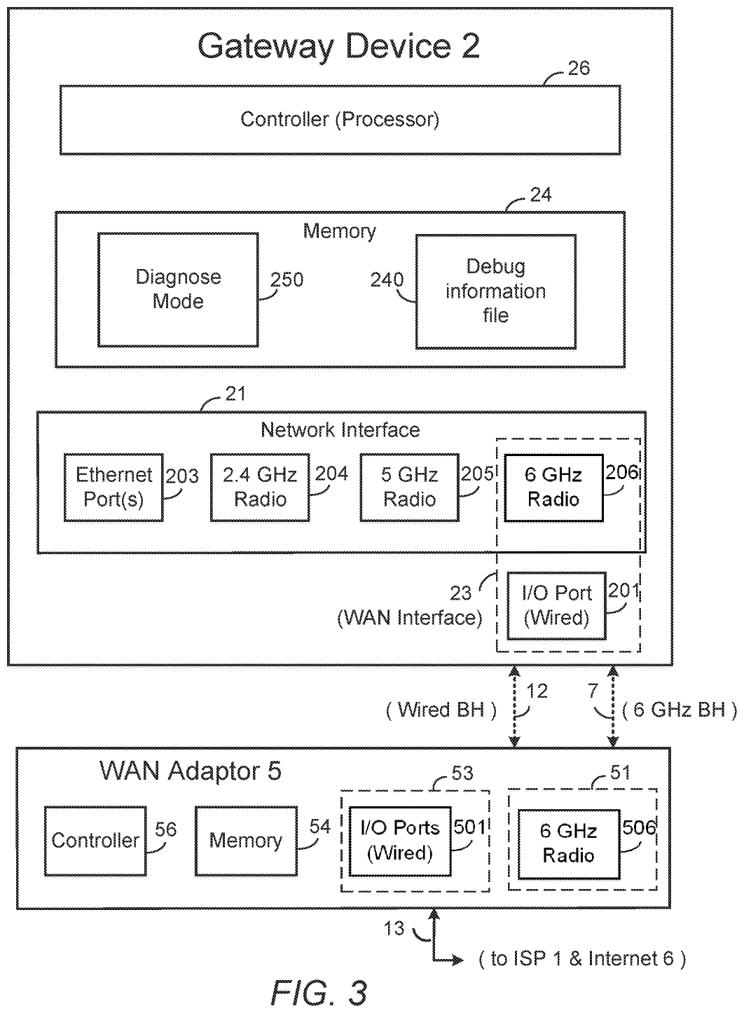

A more detailed description of the exemplary internal components of the gateway device 2, the wireless extenders 3, the client devices 4, and the WAN adaptor 5 shown in FIG. 1 will be provided in the discussion of FIGS. 2 and 3. However, in general, it is contemplated by the present disclosure that the gateway device 2, the wireless extenders 3, the client devices 4, and the WAN adaptor 5 include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium (e.g., a non-transitory computer-readable medium).

Further, any, all, or some of the computing components in the gateway device 2, the wireless extenders 3, the client devices 4, and the WAN adaptor 5 may be adapted to execute any operating system, including Linux, UNIX, Windows, MacOS, DOS, and ChromOS as well as virtual machines adapted to virtualize execution of a particular operating system, including customized and proprietary operating systems. The gateway device 2, the wireless extenders 3, the client devices 4, and the WAN adaptor 5 are further equipped with components to facilitate communication with other computing devices over the one or more network connections to local and wide area networks, wireless and wired networks, public and private networks, and any other communication network enabling communication in the system.

FIG. 2 is a more detailed block diagram illustrating various components of an exemplary gateway device, client device, and wireless extender implemented in the system of FIG. 1, according to an embodiment of the present disclosure.

Although FIG. 2 only shows one wireless extender 3 and one client device 4, the wireless extender 3 and the client device 4 shown in the figure are meant to be representative of the other wireless extenders 3 and client devices 4 shown in FIG. 1. Similarly, the connections 8, 9, 10, and 11 between the gateway device 2, the wireless extender 3, and the client device 4 shown in FIG. 2 are meant to be exemplary connections and are not meant to indicate all possible connections between the gateway devices 2, wireless extenders 3, and client devices 4. Additionally, it is contemplated by the present disclosure that the number of gateway devices 2, wireless extenders 3, and client devices 4 is not limited to the number of gateway devices 2, wireless extenders 3, and client devices 4 shown in FIGS. 1 and 2.

Now referring to FIG. 2 (e.g., from left to right), the client device 4 can be, for example, a computer, a portable device, an electronic tablet, an e-reader, a PDA, a smart phone, a smart speaker, an IoT device, an iControl device, portable music player with smart capabilities capable of connecting to the Internet, cellular networks, and interconnecting with other devices via Wi-Fi and Bluetooth, or other wireless hand-held consumer electronic device capable of executing and displaying the content received through the gateway device 2. Additionally, the client device 4 can be a TV, an IP/QAM STB, or an SMD that is capable of decoding audio/video content, and playing over OTT or MSO provided content received through the gateway device 2.

As shown in FIG. 2, the client device 4 includes a user interface 40, a network interface 41, a power supply 42, a memory 44, and a controller 46.

The user interface 40 includes, but is not limited to, push buttons, a keyboard, a keypad, a liquid crystal display (LCD), a thin film transistor (TFT), a light-emitting diode (LED), a high definition (HD) or other similar display device including a display device having touch screen capabilities so as to allow interaction between a user and the client device 4.

The network interface 41 can include, but is not limited to, various network cards, interfaces, and circuitry implemented in software and/or hardware to enable communications with the gateway device 2 and the wireless extender 3 using the communication protocols in accordance with connections 9, 10, and/or 11 (e.g., as described with reference to FIG. 1).

For example, the network interface 41 can include multiple radios (e.g., a 2.4 GHz radio, one or more 5 GHz radios, and/or a 6 GHz radio), which may also be referred to as wireless local area network (WLAN) interfaces. The radios (e.g., 2.4 GHz, 5 GHz, and/or 6 GHz radio(s)) provide a fronthaul (FH) connection between the client device(s) 4 and the gateway device 2 and/or the wireless extender 3.

The power supply 42 supplies power to the internal components of the client device 4 through the internal bus 47. The power supply 42 can be a self-contained power source such as a battery pack with an interface to be powered through an electrical charger connected to an outlet (e.g., either directly or by way of another device). The power supply 42 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The memory 44 includes a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), a hard disk or any other various layers of memory hierarchy. The memory 44 can be used to store any type of instructions, software, or algorithms including software 45 for controlling the general function and operations of the client device 4 in accordance with the embodiments described in the present disclosure.

The controller 46 controls the general operations of the client device 4 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 45 for controlling the operation and functions of the client device 4 in accordance with the embodiments described in the present disclosure. Communication between the components (e.g., 40, 41, 42, 44, 46) of the client device 4 may be established using an internal bus 47.

The wireless extender 3 can be, for example, a hardware electronic device such as an access point (AP) used to extend a wireless network by receiving the signals transmitted by the gateway device 2 and rebroadcasting the signals to client devices 4, which may be out of range of the gateway device 2. The wireless extender 3 can also receive signals from the client devices 4 and rebroadcast the signals to the gateway device 2, mobile device 5, or other client devices 4.

As shown in FIG. 2, the wireless extender 3 includes a user interface 30, a network interface 31, a power supply 32, a memory 34, and a controller 36.

The user interface 30 can include, but is not limited to, push buttons, a keyboard, a keypad, an LCD, a TFT, an LED, an HD or other similar display device including a display device having touch screen capabilities so as to allow interaction between a user and the wireless extender 3.

The network interface 31 can include various network cards, interfaces, and circuitry implemented in software and/or hardware to enable communications with the client device 4 and the gateway device 2 using the communication protocols in accordance with connections 8, 9, and/or 11 (e.g., as described with reference to FIG. 1). For example, the network interface 31 can include multiple radios or sets of radios (e.g., a 2.4 GHz radio, one or more 5 GHz radios, and/or a 6 GHz radio), which may also be referred to as wireless local area network (WLAN) interfaces. One radio or set of radios (e.g., 5 GHz and/or 6 GHz radio(s)) provides a backhaul (BH) connection between the wireless extender 3 and the gateway device 2, and optionally other wireless extender(s) 3. Another radio or set of radios (e.g., 2.4 GHz, 5 GHz, and/or 6 GHz radio(s)) provides a fronthaul (FH) connection between the wireless extender 3 and one or more client device(s) 4.

The power supply 32 supplies power to the internal components of the wireless extender 3 through the internal bus 37. The power supply 32 can be connected to an electrical outlet (e.g., either directly or by way of another device) via a cable or wire.

The memory 34 can include a single memory or one or more memories or memory locations that include, but are not limited to, a RAM, a DRAM, a memory buffer, a hard drive, a database, an EPROM, an EEPROM, a ROM, a flash memory, logic blocks of an FPGA, hard disk or any other various layers of memory hierarchy. The memory 34 can be used to store any type of instructions, software, or algorithm including software 35 associated with controlling the general functions and operations of the wireless extender 3 in accordance with the embodiments described in the present disclosure.

The controller 36 controls the general operations of the wireless extender 3 and can include, but is not limited to, a CPU, a hardware microprocessor, a hardware processor, a multi-core processor, a single core processor, an FPGA, a microcontroller, an ASIC, a DSP, or other similar processing device capable of executing any type of instructions, algorithms, or software including the software 35 for controlling the operation and functions of the wireless extender 3 in accordance with the embodiments described in the present disclosure. General communication between the components (e.g., 30, 31, 32, 34, 36) of the wireless extender 3 may be established using the internal bus 37.

The gateway device 2 can be, for example, a hardware electronic device that can combine the functions of a modem, an access point (AP), and/or a router for providing content received from the content provider (ISP) 1 to network devices (e.g., wireless extenders 3, client devices 4) in the system. It is also contemplated by the present disclosure that the gateway device 2 can include the function of, but is not limited to, an IP/QAM STB or SMD that is capable of decoding audio/video content, and playing OTT or MSO provided content.

As shown in FIG. 2, the gateway device 2 includes a user interface 20, a network interface 21, a power supply 22, a wide area network (WAN) interface 23, a memory 24, and a controller 26.

The user interface 20 can include, but is not limited to, push buttons, a keyboard, a keypad, an LCD, a TFT, an LED, an HD or other similar display device including a display device having touch screen capabilities so as to allow interaction between a user and the gateway device 2.

The network interface 21 may include various network cards, and circuitry implemented in software and/or hardware to enable communications with the wireless extender 3 and the client device 4 using the communication protocols in accordance with connections 8, 9, 10, and/or 11 (e.g., as described with reference to FIG. 1). For example, the network interface 21 can include an Ethernet port (also referred to as a LAN interface) and multiple radios or sets of radios (e.g., a 2.4 GHz radio, one or more 5 GHz radios, and/or a 6 GHz radio, also referred to as WLAN interfaces). One radio or set of radios (e.g., 5 GHz and/or 6 GHz radio(s)) can provide a wireless backhaul (BH) connection between the gateway device 2 and the wireless extender(s) 3. Another radio or set of radios (e.g., 2.4 GHz, 5 GHz, and/or 6 GHz radio(s)) can provide a fronthaul (FH) connection between the gateway device 2 and one or more client device(s) 4.

The power supply 22 supplies power to the internal components of the gateway device 2 through the internal bus 27. The power supply 22 can be connected to an electrical outlet (e.g., either directly or by way of another device) via a cable or wire.

The WAN interface 23 may include various network cards, and circuitry implemented in software and/or hardware to enable communications between the gateway device 2 and the Internet 6, via the ISP 1 and the WAN adaptor 5, using the wired and/or wireless protocols in accordance with connection 7 (e.g., as described with reference to FIG. 1). For example, the WAN interface 23 can include an Ethernet port and one or more radios (e.g., a 6 GHz radio). The WAN interface 23 (e.g., 6 GHz radio) may be used to provide a wireless backhaul (BH) connection between the gateway device 2 and the WAN adaptor 5 (e.g., as described with reference to FIG. 1, and further described with reference to FIG. 3 below), according to example embodiments of the present disclosure. However, the WAN interface 23 could provide a wired Ethernet connection (e.g., a BH connection) between the gateway device 2 and the WAN adaptor 5 according to some alternative example embodiments.

The memory 24 includes a single memory or one or more memories or memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be used to store any type of instructions, software, or algorithm including software 25 for controlling the general functions and operations of the gateway device 2 and performing management functions related to the other devices (e.g., wireless extenders 3 and client devices 4) in the network in accordance with the embodiments described in the present disclosure (e.g., including a virtual interface function according to some example embodiments of the present disclosure).

The controller 26 controls the general operations of the gateway device 2 as well as performs management functions related to the other devices (e.g., wireless extenders 3 and client device 4) in the network. The controller 26 may also be referred to as a gateway access point (AP) wireless resource controller. The controller 26 can include, but is not limited to, a central processing unit (CPU), a hardware microprocessor, a hardware processor, a multi-core processor, a single core processor, a FPGA, a microcontroller, an ASIC, a DSP, or other similar processing device capable of executing any type of instructions, algorithms, or software including the software 25 for controlling the operation and functions of the gateway device 2 in accordance with the embodiments described in the present disclosure. Communication between the components (e.g., 20, 21, 22, 23, 24, 26) of the gateway device 2 may be established using the internal bus 27. The controller 26 may also be referred to as a processor, generally.

FIG. 3 is a more detailed block diagram illustrating certain components of an exemplary gateway device and an exemplary wide area network adaptor implemented in the system of FIG. 1, according to an embodiment of the present disclosure.

As shown in FIG. 3, the gateway device 2 includes the network interface 21, the WAN interface 23, the memory 24, and the controller (processor) 26.

The network interface 21 includes Ethernet port(s) 203 (e.g., wired LAN interfaces), a 2.4 GHz radio 204, a 5 GHz radio 205, and a 6 GHz radio 206 (e.g., wireless LAN interfaces, or WLAN interfaces). The gateway device 2 may communicate with the local area network devices (e.g., the wireless extenders 3, the client devices 4) of the system via one or more of the Ethernet port(s) 203, the 2.4 GHz radio 204, the 5 GHz radio 205, and/or the 6 GHz radio 206. As shown in FIG. 3, the WAN interface 23 may include a wireless interface such as the 6 GHz radio 206 and/or a wired interface such as the I/O port 201 (e.g., Ethernet, coaxial RF cable, etc.). Thus, the gateway device 2 may communicate with the wide area network devices (e.g., the WAN adaptor 5) via the 6 GHz radio 206 and/or the I/O port 201. As mentioned above, according to aspects of the present disclosure, one radio or set of radios can provide a backhaul (BH) connection between the gateway device 2, the wireless extender(s) 3 and the WAN adaptor 5, while another radio or set of radios can provide a fronthaul (FH) connection between the gateway device 2 and the client device(s) 4. However, the gateway device 2 may communicate with the LAN devices (e.g., the wireless extenders 3, the client devices 4) and/or the WAN devices (e.g., the WAN adaptor 5) via wired connections (e.g., Ethernet ports) according to some alternative example embodiments.

The memory 24 includes a diagnose mode 250 and a debug information file 240. The diagnose mode 250 may be implemented as part of the instructions, algorithms, or software including the software 25 described above with reference to FIG. 2. The debug information file 240 may be a data structure storing various pieces of information collected by the gateway device 2 upon entering the diagnose mode for use when performing remote debugging operations in accordance with embodiments described in the present disclosure.

The controller 26 includes a processor that is configured to access the memory 24, perform the diagnose mode 250 (e.g., via execution of the software 25), and execute commands or perform other operations based on the information in the debug information file 240. The controller 26 also controls communications with the network devices (e.g., the wireless extenders 3, the client devices 4, and the WAN adaptor 5) via the Ethernet port(s) 203, the 2.4 GHz radio 204, the 5 GHz radio 205, and/or the 6 GHz radio 206 in accordance with embodiments described in the present disclosure.

As shown in FIG. 3, the WAN adaptor 5 includes the network interface 51, the WAN interface 53, the memory 54, and the controller 56.

The network interface 51 may include various network cards, and circuitry implemented in software and/or hardware to enable communications with the gateway device 2 using the communication protocols in accordance with connection 7 (e.g., as described with reference to FIG. 1). For example, the network interface 51 can include a 6 GHz radio 506. The WAN adaptor 5 may communicate with the gateway device 2 via the 6 GHz radio 506. As mentioned above, according to aspects of the present disclosure, the 6 GHz radio 506 can provide a 6 GHz wireless backhaul (BH) connection between the WAN adaptor 5 and the gateway device 2. However, the WAN adaptor 5 may communicate with the gateway device 2 using the communication protocols in accordance with connection 12 (e.g., as described with reference to FIG. 1), via one of the I/O ports 501 (e.g., an Ethernet port) of the WAN adaptor 5, according to some other example embodiments.

The WAN interface 53 may include various network cards, and circuitry implemented in software and/or hardware to enable communications between the WAN adaptor 5 and the Internet 6 via the ISP 1 using the communication protocols in accordance with connection 13 (e.g., as described with reference to FIG. 1). For example, the WAN interface 53 can include one or more I/O ports 501, which may provide a wired connection (e.g., Ethernet, cable, fiber, or the like) between the WAN adaptor 5 and the ISP 1 (e.g., via the ONT 16 as described with reference to FIG. 1). The WAN adaptor 5 may also communicate with the file server 17 of the ISP 1 via the WAN interface 53 (e.g., the wired connection of one of the I/O ports 501).

The memory 54 includes a single memory or one or more memories or memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 54 can be used to store any type of instructions, software, or algorithm for controlling the general functions and operations of the WAN adaptor 5 in accordance with the embodiments described in the present disclosure.

The controller 56 includes a processor that is configured to access the memory 54 and control the general operations of the WAN adaptor 5. The controller 56 can include, but is not limited to, a central processing unit (CPU), a hardware microprocessor, a hardware processor, a multi-core processor, a single core processor, a FPGA, a microcontroller, an ASIC, a DSP, or other similar processing device capable of executing any type of instructions, algorithms, or software for controlling the operation and functions of the WAN adaptor 5 in accordance with the embodiments described in the present disclosure. The controller 56 also controls communications with the gateway device 2 via the network interface 51 (e.g., the 6 GHz radio 506 and/or one of the wired I/O ports 501) and with the ISP 1 via the WAN interface 53 (e.g., one of the I/O ports 501) in accordance with example embodiments described in the present disclosure.

As mentioned above, certain issues may arise in a residential gateway (RG) device, such as the gateway device 2, that require debugging to be performed. For example, the gateway device 2 may have a radio frequency (RF) connectivity problem, which prevents the gateway device 2 from ranging and registering to a cable modem termination system (CMTS). There may be other problems such as an unplugged or damaged cable, a faulty connection, or interference.

In some cases, a technician may be able to communicate remotely with the gateway device 2, in order to collect logs and/or upgrade the firmware of the gateway device to address these issues. However, known remote debugging techniques, such as Simple Network Management Protocol (SNMP)/Technical Report 069 (TR-069), encrypted tunneling to the gateway device using secure shell (SSH), and graphical user interfaces (GUIs), for example, all rely on the Wide Area Network (WAN) connection of the gateway device 2 to allow the debugging operations to be performed on the gateway device 2 via a remote device of the MSO technician. Thus, there is a problem that the MSO technician will be unable to communicate with the gateway device 2 using any of these known remote debugging techniques in the event that the gateway device 2 loses its WAN connection. Accordingly, there is a need for an improved technique that enables remote debugging to be performed with respect to a gateway device 2 (or other wireless access point) without relying on the WAN side Internet connectivity of the gateway device 2. It would also be desirable to enable remote updating of a configuration file stored on the gateway device 2 and/or remote upgrading of firmware of the gateway device 2 to be performed in a similar manner, even when the WAN connection of the gateway device 2 is lost.

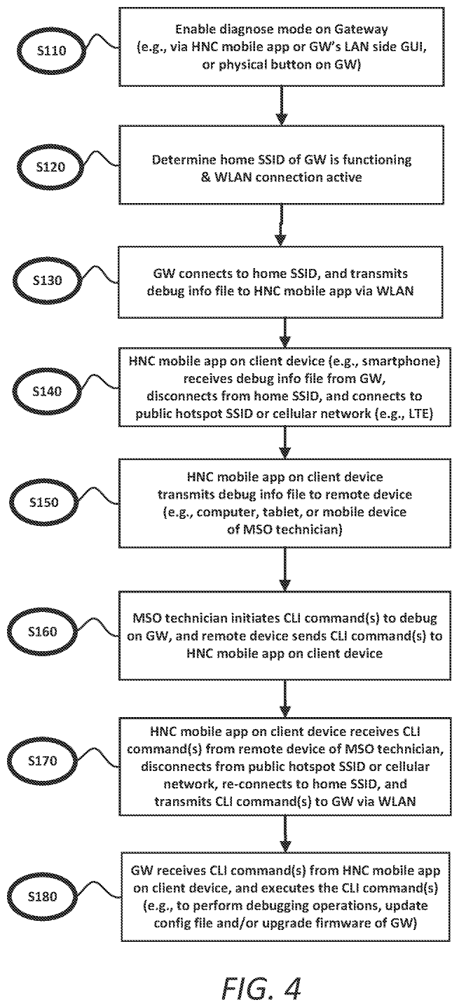

FIG. 4 is a flow chart illustrating a method for remotely debugging a gateway device when the WAN connection of the gateway device is lost, according to an example embodiment of the present disclosure.

To address the problem with the known remote debugging techniques discussed above, a “diagnose mode” is introduced on the gateway device 2 according to aspects of the present disclosure. The method of FIG. 4 may begin with enabling the diagnose mode on the gateway device 2, at step S110. For example, causing the gateway device 2 to enter the diagnose mode can be triggered using a wireless connection with a client device 4, such as a mobile device of a user (e.g., the customer's smartphone or other similar electronic device), via a home network controller (HNC) mobile application installed on the client device 4. Alternatively, the user can trigger the gateway device 2 to enter the diagnose mode locally using a LAN side graphical user interface (GUI) of the gateway device 2 or by pressing a physical button on the gateway device 2. In either case, the MSO technician no longer needs to be present on site at the customer's home to perform debugging operations locally at the gateway device 2, and the MSO technician can still provide various forms of support remotely even when the gateway device 2 loses its WAN connection.

In the diagnose mode, the gateway device 2 will dump various useful debug information into a local file. In some example embodiments, the gateway device 2 may encrypt the local file with the debug information and store the local file (e.g., the debug information file 240 discussed above with reference to FIG. 3) in the memory 24 of the gateway device 2. The local file with the debug information may have the following format, for example:

Example File Name: Debug_info_userID_xxx.txt

User ID
Timestamp
CM MAC address
RF transmission power
Last used frequency and DOCSIS channel
Last reset reason
Memory remaining
etc. [...]

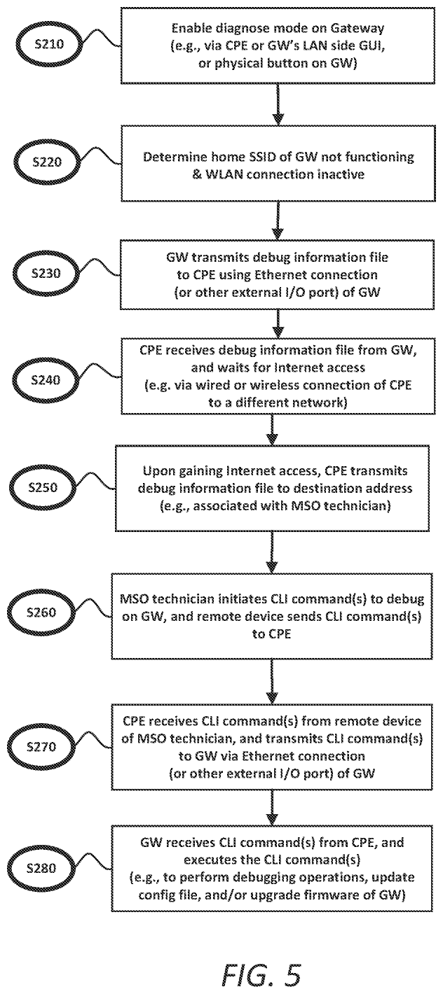

At step S120, the method may include determining whether the home Service Set Identifier (SSID) of the gateway device 2 is functioning, and the wireless local area network (WLAN) connection associated with the home SSID is active. If the home SSID of the gateway device 2 is still functioning and the WLAN connection associated with the home SSID remains active, the method may proceed to step S130 of FIG. 4. In cases where the home SSID of the gateway device 2 is no longer functioning and the WLAN connection associated with the home SSID is now inactive, the method discussed below with reference to FIG. 5 may apply.

When it is determined that the home SSID of the gateway device 2 is still functioning and the WLAN connection associated with the home SSID remains active at step S120, the gateway device 2 can connect to the home SSID and transmit debug information to the HNC mobile application on the client device 4, such as the mobile device of the user (e.g., the customer's smartphone), using the WLAN connection associated with the home SSID, at step S130.

After the client device 4 is finished collecting the debug information from the gateway device 2, the client device 4 (e.g., mobile device, smartphone, etc.) will automatically disconnect from this home SSID and connect to an available public hotspot SSID, or alternatively, connect to a cellular network (e.g., LTE or the like) for Internet access, at step S140. Then, once the client device 4 gains Internet access, the client device 4 (e.g., mobile device, smartphone, etc.) can transmit the debug information to a remote device (e.g., a computer, tablet, mobile device, smartphone, etc.) of the MSO technician using the WLAN connection associated with the public hotspot SSID, or alternatively, using the connection with the cellular network, at step S150. In some example embodiments, the debug information may be encrypted on the client device 4 (e.g., mobile device, smartphone), and will be sent out to the MSO technician as soon as the smartphone has internet access.

For example, the MSO may configure a pre-defined policy that allows a client device 4 equipped with the HNC mobile application to access public hotspots in association with the limited purpose of transmitting debug information only. The MSO policy may waive any fees associated with using a public hotspot to transmit debug information, specifically. A destination address of the MSO technician may be configured on the HNC mobile application, and may be associated with an email account of the MSO technician or a trivial file transfer protocol (TFTP) server accessible by the MSO technician. However, this could also be implemented using some other protocol or a generic protocol.

Once the MSO technician receives the debug information from the client device 4, the MSO technician can initiate one or more command line interface (CLI) command(s) and/or instruction(s) to debug on the gateway device 2, and the remote device of the MSO technician will send the CLI command(s) and/or instruction(s) to the HNC mobile application on the client device 4, at step S160.

For example, the MSO technician can transmit a single command, a list of commands, one or more executables, one or more files, one or more instructions, etc. for remotely troubleshooting the gateway device 2. The CLI command(s) and/or instruction(s) may relate to performing various debugging operations (e.g., associated with CPU usage, memory dump, software reset, reboot, restoring default settings, or the like). Additionally or alternatively, the CLI command(s) and/or instruction(s) may relate to updating a configuration file stored in the memory of the gateway device 2, and/or upgrading firmware of the gateway device 2.

At step S170, the HNC mobile application on the client device 4 receives CLI command(s) and/or instruction(s) from the remote device of the MSO technician using the WLAN connection associated with the public hotspot SSID, or alternatively, the connection with the cellular network, automatically disconnects from the public hotspot SSID or the cellular network and reconnects to the home SSID of the gateway device 2, and transmits the CLI command(s) and/or instruction(s) to the gateway device 2 using the WLAN connection associated with the home SSID.

Finally, at step S180, the gateway device 2 receives the CLI command(s) and/or instruction(s) from the HNC mobile application on the client device 4, and executes the CLI command(s) and/or instruction(s) to debug on the gateway device 2. For example, the one or more CLI command(s) and/or instruction(s) may cause the gateway device 2 to perform various debugging operations, to update a configuration file stored on the gateway device 2, and/or to upgrade firmware of the gateway device 2.

In some example embodiments, one or more of these features may be performed simultaneously in one round of communications between the client device 4, the gateway device 2, and the remote device of the MSO technician. In some other example embodiments, one or more steps of the method may be repeated in an iterative process, as needed, in multiple rounds of communications for performing each of these features, respectively, for remotely troubleshooting the gateway device 2.

In yet some other example embodiments, the debugging operations can even be bi-directional. For example, the MSO technician can initiate some command to the gateway device 2 (e.g., via the HNC mobile app of the client device 4) and trigger the client device 4 (e.g., the mobile device of the user, such as the customer's smartphone) to disconnect from the public hotspot SSID or cellular network and connect back to the home SSID to execute that command on the gateway device 2.

FIG. 5 is a flow chart illustrating a method for remotely debugging a gateway device when the WAN connection of the gateway device is lost, according to an example embodiment of the present disclosure.

In addition to the method of FIG. 4, the method of FIG. 5 may begin with enabling the diagnose mode on the gateway device 2, at step S210. In this example embodiment, causing the gateway device 2 to enter the diagnose mode can be triggered via a wired connection with a customer premises equipment (CPE). In some example embodiments, the CPE may be a laptop computer (e.g., with Ethernet connectivity or other suitable I/O port). In some other example embodiments, the CPE could be a tablet or a mobile device (e.g., the customer's smartphone) with an adapter (e.g., a separate piece of physical hardware, such as a USB or USB Type C to Ethernet connector) for connecting the CPE to the gateway device 2 to enable the debugging procedure. As mentioned above, the user can also trigger the gateway device 2 to enter the diagnose mode using the local (LAN side) GUI of the gateway device 2, or by pressing the physical button on the gateway device 2. In either case, the MSO technician no longer needs to be present on site at the customer's home to perform debugging operations locally at the gateway device 2, and the MSO technician can still provide various forms of support remotely even when the gateway device 2 loses its WAN connection. Further, the method of FIG. 5 does not rely on a wireless connection with the gateway device 2 (e.g., using the home SSID of the gateway device 2 and the WLAN connection associated with the home SSID) to transmit and receive the debugging information, CLI command(s), etc., and instead uses a wired connection (e.g., Ethernet or other external I/O port) directly between the CPE and the gateway device 2.

At step S220, the method may include determining that the home SSID of the gateway device 2 is not functioning, and the WLAN connection associated with the home SSID is inactive. If the home SSID of the gateway device 2 is no longer functioning and the WLAN connection associated with the home SSID is now inactive, the method may proceed to step S230 of FIG. 5. In cases where the home S SID of the gateway device 2 is still functioning and the WLAN connection associated with the home SSID remains active, the method discussed above with reference to FIG. 4 may apply.

When it is determined that the home SSID is no longer functioning and the WLAN connection associated with the home SSID is now inactive at step S220, the gateway device 2 can still use an Ethernet connection (or another external input/output (I/O) port) to transfer the debug information to the CPE, at step S230. The CPE can still get an IP address and communicate with the gateway device 2, even when the WAN connection of the gateway device 2 is down.

After the CPE is finished collecting the debug information from the gateway device 2, the CPE waits for Internet access, at step S240. In situations where the WAN connection of the gateway device 2 is down and the home SSID no longer works, the CPE cannot access the Internet via the gateway device 2 and the user will need to connect the CPE to another network to communicate with the MSO technician for the debug procedure. For example, the user may disconnect the CPE from the wired Ethernet connection with the gateway device 2, and connect the CPE to a different network for internet access (e.g., a network at another location such as work/office, school, neighbor, family member, restaurant, public hotspot, etc.). Once the CPE gains Internet access via the different network, the CPE will transmit the debug information to a destination address (e.g., associated with the MSO technician) using a wired or wireless connection of the CPE to the different network, at step S250. The destination address of the MSO technician may be configured on the CPE, and may be associated with an email account of the MSO technician or a trivial file transfer protocol (TFTP) server accessible by the MSO technician. However, this could also be implemented using some other protocol or a generic protocol. In some example embodiments, the debug information may be encrypted on the CPE, and will be sent out to the MSO technician as soon as the CPE has internet access.

Once the MSO technician receives the debug information from the CPE, the MSO technician can initiate one or more command line interface (CLI) command(s) and/or instruction(s) to debug on the gateway device 2, and the remote device of the MSO technician will send the CLI command(s) and/or instruction(s) to the CPE, at step S260.

At step S270, the CPE receives the CLI command(s) and/or instruction(s) from the remote device of the MSO technician using the wired or wireless connection of the CPE to the different network, and transmits the CLI command(s) and/or instruction(s) to the gateway device 2 using the Ethernet connection (or other external I/O port) of the gateway device 2. For example, once the CPE receives the instructions for debugging the gateway device 2 from the remote device of the MSO technician, the user may disconnect the CPE from the different network and reconnect the CPE to the gateway device 2 using the wired Ethernet connection (e.g., when the user returns home from the location of the different network).

Finally, at step S280, the gateway device 2 receives the CLI command(s) and/or instruction(s) from the CPE, and executes the CLI command(s) and/or instruction(s) to debug on the gateway device 2. For example, the one or more CLI command(s) and/or instruction(s) may cause the gateway device 2 to perform various debugging operations, to update a configuration file stored on the gateway device 2, and/or to upgrade firmware of the gateway device 2.

In some example embodiments, one or more of these features may be performed simultaneously in one round of communications between the CPE, the gateway device 2, and the remote device of the MSO technician. In some other example embodiments, one or more steps of the method may be repeated in an iterative process, as needed, in multiple rounds of communications for performing each of these features, respectively, for remotely troubleshooting the gateway device 2.

According to the method(s) of FIG. 4 and/or FIG. 5, the MSO technician can still collect useful debug information from a problematic gateway device remotely, even when the WAN connection of the gateway device is lost (e.g., the Internet is not accessible). Thus, the method(s) enable remote debugging to be performed (and/or configuration files to be updated, and/or firmware upgrades to be installed) with respect to a gateway device 2, even when the WAN interface of the gateway device 2 is down. As compared to known techniques, the solutions according to aspects of the present disclosure would be effective to fix problems with the gateway device 2 more quickly and conveniently as well as to reduce or eliminate a significant amount of labor costs associated with sending MSO technicians on site to perform debugging and/or other troubleshooting operations locally when the WAN interface of the gateway device is not functioning.

In some other example embodiments, Long Term Evolution Wi-Fi Link Aggregation technology (also referred to as LTE-H) combines two heterogeneous networks, LTE and Wi-Fi, and enables simultaneous WLAN and cellular data links on a mobile device of a user (e.g., the customer's smartphone or other similar electronic device). With advances in LTE-H, the solutions according to various aspects of the present disclosure can be even easier and faster to use.

The gateway device 2 may be programmed with instructions (e.g., controller instructions) to execute the diagnose mode and collect the debug information in some example embodiments, or may use its native software in some other example embodiments. In FIGS. 4-5, it is assumed that the devices include their respective controllers or processors and their respective software stored in their respective memories, as discussed above in connection with FIGS. 2-3, which when executed by their respective controllers or processors perform the functions and operations for remotely debugging a gateway device in accordance with the example embodiments of the present disclosure.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A gateway device comprising:
a memory storing instructions for enabling the gateway device to be debugged remotely when a wide area network (WAN) connection of the gateway device is lost; and
a processor configured to execute the instructions to:
enter a diagnose mode to collect debug information when the WAN connection of the gateway device is lost;
transmit the debug information to an electronic device associated with a local area network (LAN) of the gateway device;
receive command line interface (CLI) instructions from the electronic device based on the debug information; and
perform one or more debug operations on the gateway device based on the CLI instructions.

2. The gateway device according to claim 1, wherein:
the electronic device associated with the LAN of the gateway device is a mobile device; and
when a home service set identifier (SSID) associated with the gateway device is functioning and a wireless local area network (WLAN) connection associated with the home SSID is active, the processor of the gateway device is configured to execute the instructions to:
transmit the debug information to the mobile device over the WLAN connection associated with the home SSID of the gateway device; and
receive the CLI instructions from the mobile device over the WLAN connection associated with the home SSID of the gateway device.

3. The gateway device according to claim 2, wherein entering the diagnose mode is triggered via one of:
a home network controller (HNC) mobile application executing on the mobile device;
a LAN side graphical user interface (GUI) of the gateway device; or
a physical button on the gateway device.

4. The gateway device according to claim 1, wherein:
the electronic device associated with the LAN of the gateway device is a customer premises equipment (CPE); and
when a home service set identifier (SSID) associated with the gateway device is not functioning and a wireless local area network connection (WLAN) associated with the home SSID is inactive, the processor of the gateway device is configured to execute the instructions to:
transmit the debug information to the CPE over a wired Ethernet connection; and
receive the CLI instructions from the CPE over the wired Ethernet connection.

5. The gateway device according to claim 1, wherein, upon entering the diagnose mode, the processor is configured to execute the instructions to:
collect the debug information, wherein the collected debug information includes one or more of a user ID, a timestamp, a media access control (MAC) address of the gateway device, a radio frequency (RF) transmission power, last used frequency and DOCSIS channel, last reset reasons, and memory remaining;
store the collected debug information in a local file; and
encrypt the local file storing the debug information.

6. A non-transitory computer-readable medium storing instructions for enabling a gateway device to be debugged remotely when a wide area network (WAN) connection of the gateway device is lost, the instructions when executed by a processor of the gateway device causing the gateway device to perform operations comprising:
entering a diagnose mode to collect debug information when the WAN connection of the gateway device is lost;
transmitting the debug information to an electronic device associated with a local area network (LAN) of the gateway device;
receiving command line interface (CLI) instructions from the electronic device based on the debug information; and
perform one or more debug operations on the gateway device based on the CLI instructions.

7. The non-transitory computer-readable medium according to claim 6, wherein:
the electronic device associated with the LAN of the gateway device is a mobile device; and
when a home service set identifier (SSID) associated with the gateway device is functioning and a wireless local area network (WLAN) connection associated with the home SSID is active, the instructions when executed by the processor of the gateway device cause the gateway device to perform operations comprising:
transmitting the debug information to the mobile device over the WLAN connection associated with the home SSID of the gateway device; and
receiving the CLI instructions from the mobile device over the WLAN connection associated with the home SSID of the gateway device.

8. The non-transitory computer-readable medium according to claim 7, wherein entering the diagnose mode is triggered via one of:
a home network controller (HNC) mobile application executing on the mobile device;
a LAN side graphical user interface (GUI) of the gateway device; or
a physical button on the gateway device.

9. The non-transitory computer-readable medium according to claim 6, wherein:
the electronic device associated with the LAN of the gateway device is a customer premises equipment (CPE); and
when a home service set identifier (SSID) associated with the gateway device is not functioning and a wireless local area network connection (WLAN) associated with the home SSID is inactive, the instructions when executed by the processor of the gateway device cause the gateway device to perform operations comprising:
transmitting the debug information to the CPE over a wired Ethernet connection; and
receiving the CLI instructions from the CPE over the wired Ethernet connection.

10. The non-transitory computer-readable medium according to claim 6, wherein, upon entering the diagnose mode, the instructions when executed by the processor of the gateway device cause the gateway device to perform operations comprising:
collecting the debug information, wherein the collected debug information includes one or more of a user ID, a timestamp, a media access control (MAC) address of the gateway device, a radio frequency (RF) transmission power, last used frequency and DOCSIS channel, last reset reasons, and memory remaining;
storing the collected debug information in a local file; and
encrypting the local file storing the debug information.

11. A method for remotely debugging a gateway device when a wide area network (WAN) connection of the gateway device is lost, the method comprising:
causing the gateway device to enter a diagnose mode to collect debug information when the WAN connection of the gateway device is lost;
transmitting the debug information from the gateway device to an electronic device associated with a local area network (LAN) of the gateway device;
receiving command line interface (CLI) instructions at the gateway device from the electronic device based on the debug information; and
performing one or more debug operations on the gateway device based on the CLI instructions.

12. The method according to claim 11, wherein:
the electronic device associated with the LAN of the gateway device is a mobile device; and
when a home service set identifier (SSID) associated with the gateway device is functioning and a wireless local area network (WLAN) connection associated with the home SSID is active, the method comprises:
transmitting the debug information from the gateway device to the mobile device over the WLAN connection associated with the home SSID of the gateway device; and
receiving the CLI instructions at the gateway device from the mobile device over the WLAN connection associated with the home SSID of the gateway device.

13. The method according to claim 12, wherein entering the diagnose mode is triggered via one of:
a home network controller (HNC) mobile application executing on the mobile device;
a LAN side graphical user interface (GUI) of the gateway device; or
a physical button on the gateway device.

14. The method according to claim 13, further comprising:
receiving the debug information at the mobile device from the gateway device via the WLAN connection associated with the home SSID;
disconnecting the mobile device from the home SSID, and connecting the mobile device with an available public hotspot SSID or a cellular network for internet access, automatically via the HNC mobile application; and
upon the mobile device gaining internet access, transmitting the debug information from the mobile device to a destination address of an multiple services operator (MSO) technician via the HNC mobile application using a WLAN connection associated with the available public hotspot SSID or using the cellular network,
wherein the destination address of the MSO technician is configured on the HNC mobile application and is associated with an email account of the MSO technician or a trivial file transfer protocol (TFTP) server accessible by the MSO technician.

15. The method of claim 14, further comprising:
receiving the CLI instructions to perform one or more of debugging operations on the gateway device, updating a configuration file stored on the gateway device, or upgrading firmware of the gateway device, at the mobile device from the MSO technician via the HNC mobile application using the WLAN connection associated with the public hotspot SSID or the cellular network;
disconnecting the mobile device from the available public hotspot SSID or the cellular network, and reconnecting the mobile device with the home SSID, automatically via the HNC mobile application; and
transmitting the CLI instructions from the mobile device to the gateway device via the HNC mobile application using the WLAN connection associated with the home SSID for execution by the gateway device.

16. The method according to claim 11, wherein:
the electronic device associated with the LAN of the gateway device is a customer premises equipment (CPE); and
when a home service set identifier (SSID) associated with the gateway device is not functioning and a wireless local area network connection (WLAN) associated with the home SSID is inactive, the method comprises:
transmitting the debug information from the gateway device to the CPE over a wired Ethernet connection; and
receiving the CLI instructions at the gateway device from the CPE over the wired Ethernet connection.

17. The method according to claim 16, further comprising:
receiving the debug information at the CPE from the gateway device over the wired Ethernet connection;
disconnecting the CPE from the wired Ethernet connection and connecting the CPE to a different network for internet access; and
upon the CPE gaining internet access, transmitting the debug information from the CPE to a destination address of an MSO technician over a wired or wireless connection of the CPE to the different network,
wherein the destination address of the MSO technician is configured on the CPE and is associated with an email account of the MSO technician or a trivial file transfer protocol (TFTP) server accessible by the MSO technician;
receiving one or more CLI commands to perform one or more of debugging operations on the gateway device, updating a configuration file stored on the gateway device, or upgrading firmware of the gateway device, at the CPE from a remote device of the MSO technician over the wired or wireless connection of the CPE to the different network;
disconnecting the CPE from the different network and connecting the CPE to the gateway device using the wired Ethernet connection; and
transmitting the one or more CLI commands from the CPE to the gateway device using the wired Ethernet connection for execution by the gateway device.

18. An electronic device associated with a local area network (LAN) of a gateway device, the electronic device comprising:
a memory storing instructions for remotely debugging a gateway device when a wide area network (WAN) connection of the gateway device is lost; and
a processor configured to execute the instructions to:
cause the gateway device to enter a diagnose mode to collect debug information when the WAN connection of the gateway device is lost;
receive the debug information from the gateway device;
transmit the debug information to a remote device of a multiple systems operator (MSO) technician;
receive command line interface (CLI) instructions from the remote device of the MSO technician based on the debug information; and
transmit the CLI instructions to the gateway device for execution.

19. The electronic device according to claim 18, wherein:
the electronic device is a mobile device, and the instructions stored in the memory are part of a home network controller (HNC) mobile application; and
when a home service set identifier (SSID) associated with the gateway device is functioning and a wireless local area network (WLAN) connection associated with the home SSID is active, the processor of the mobile device is further configured to execute the instructions of the HNC mobile application to:
receive the debug information from the gateway device via the WLAN connection associated with the home SSID;
disconnect the mobile device from the home SSID, and connect the mobile device with an available public hotspot SSID or a cellular network for internet access;
upon the mobile device gaining internet access, transmit the debug information to a destination address of the MSO technician via the HNC mobile application using a WLAN connection associated with the available public hotspot SSID or using the cellular network,
wherein the destination address of the MSO technician is configured on the HNC mobile application and is associated with an email account of the MSO technician or a trivial file transfer protocol (TFTP) server accessible by the MSO technician;
receive the command-line interface (CLI) instructions to perform one or more of debugging operations on the gateway device, update a configuration file stored on the gateway device, or upgrade firmware of the gateway device, from the remote device of the MSO technician over the WLAN connection associated with the available public hotspot SSID or the cellular network;
disconnect from the available public hotspot SSID or the cellular network, and automatically re-connect with the home SSID; and
transmit the CLI instructions to the gateway device over the WLAN connection associated with the home SSID for execution by the gateway device.

20. The electronic device according to claim 18, wherein:
the electronic device is a customer premises equipment (CPE);
when a home service set identifier (SSID) associated with the gateway device is not functioning and a wireless local area network (WLAN) connection associated with the home SSID is inactive, the processor of the CPE is configured to execute the instructions to:
receive the debug information from the gateway device over a wired Ethernet connection;
disconnect the CPE from the wired Ethernet connection and connect the CPE to a different network for internet access, and
upon the CPE gaining internet access, transmit the debug information to a destination address of the MSO technician using a wired or wireless connection of the CPE to the different network,
wherein the destination address of the MSO technician is configured on the CPE and is associated with an email account of the MSO technician or a trivial file transfer protocol (TFTP) server accessible by the MSO technician.
receive the CLI instructions to perform one or more of debugging operations on the gateway device, update a configuration file stored on the gateway device, or upgrade firmware of the gateway device, from a remote device of the MSO technician over the wired or wireless connection of the CPE to the different network;
disconnect the CPE from the different network and reconnect the CPE to the gateway device using the wired Ethernet connection; and
transmit the CLI instructions to the gateway device over the wired Ethernet connection for execution by the gateway device.
